(19) United States
(12) Patent Application Publication
(10) Pub. No.: US 2010/0165381 A1
(43) Pub. Date: Jul. 1, 2010

(54) PRINTING METHOD AND SYSTEM

(75) Inventors: YI-FANG WU, Tu-Cheng (TW); JIE YUAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/511,274

(22) Filed: Jul. 29, 2009

(30) Foreign Application Priority Data
Dec. 27, 2008 (CN) 200810306574.6

(51) Int. Cl. G06F 15/00

(52) U.S. Cl. 358/1.15

(57) ABSTRACT

A printing method and a printing system are provided. When printing a file on a client, the client is connected to a printer via a network. A print homepage is shown to the client. Then the client accesses the printer via the print homepage on the client, and sends an coded file to the printer. The printer receives the coded file from the client, and decodes the file to print. The printing system includes a client and a printer. An coded file is stored in the client. The client includes an internet browser. The printer includes a file receiving module to receive the file from the client and a print controlling module capable of controlling the printer to decode and print the coded file. A print homepage is shown on the internet browser. The client accesses the printer and sends the coded file to the printer via the print homepage.

### BACKGROUND

1. Technical Field

The present disclosure relates to printing methods and systems.

2. Description of Related Art

Nowadays, mobile electronic devices generally can store various files, such as pictures and text files for example. Sometimes, users want to print these files. Conventionally, to print a file stored in a mobile electronic device using a printer, it is necessary to install a driver corresponding to the printer onto the mobile electronic device, which is only useful for that printer, and the process must be repeated for any other printers. All of which is time-consuming and inconvenient.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a diagram of one embodiment of a printing system.

FIG. 2 is a diagram of a print homepage shown on the printing system.

FIG. 3 is a flow chart of one embodiment of a printing method.

### DETAILED DESCRIPTION

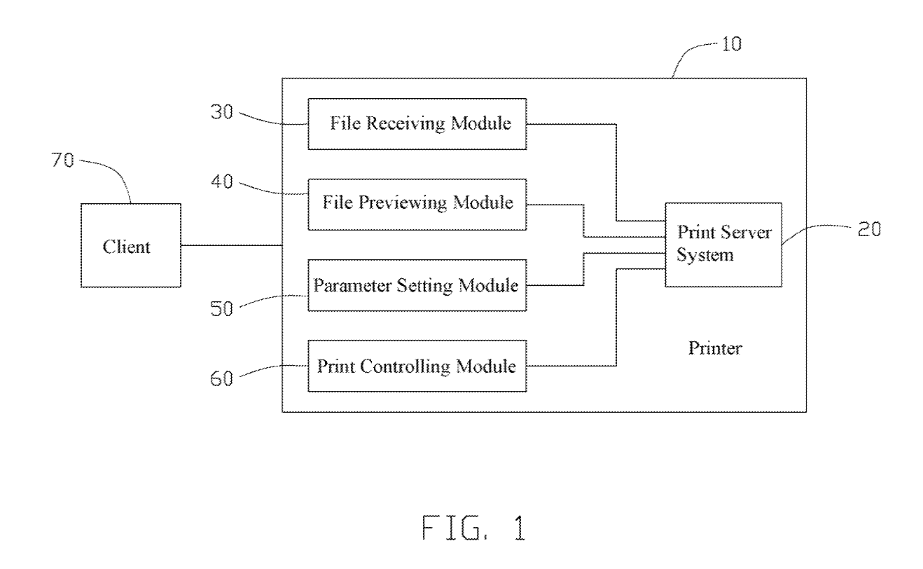

Referring to FIG. 1, an embodiment of a printing system includes a printer 10 having a print server system 20, and a client 70 connected to the printer 10 via a network, such as the Internet or local area network. The client 70 may be a desktop computer, notebook, personal digital assistant, mobile phone for example, which integrates an internet browser. The printer 10 and the client 70 are connected to the network in any known manner. For example, the printer 10 and the client 70 can be connected to the network via wireless technology or general packet radio service (GPRS) technology for example. The client 70 communicates with the printer 10 and sends files to the printer 10 via the network.

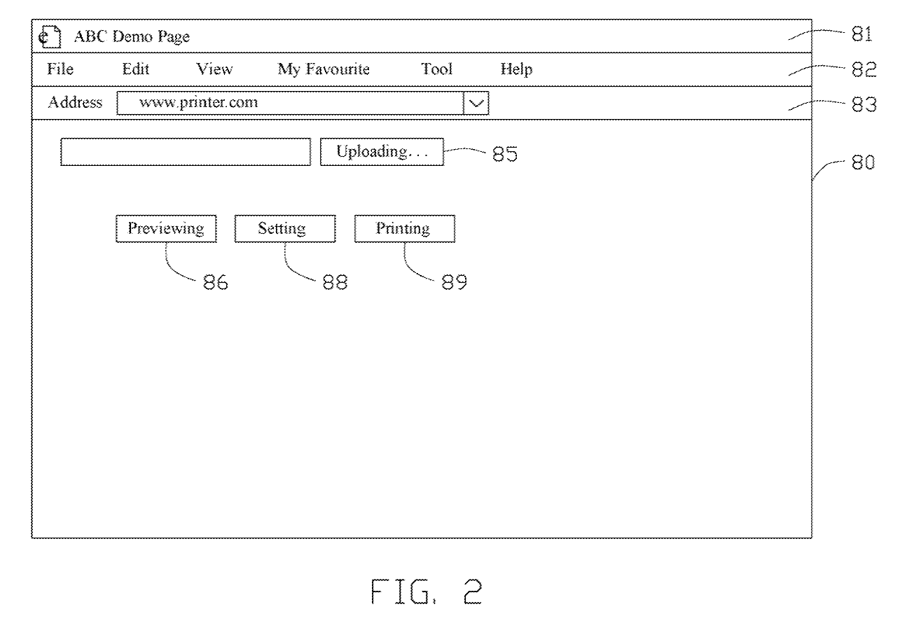

The printer 10 includes a file receiving module 30 for controlling the print server system 20 to receive coded files from the client 70, such as JPG, TIF, or TXT formatted files. The printer 10 further includes a file previewing module 40, a parameter setting module 50, and a print controlling module 60. The print controlling module 60 is configured for controlling the printer 10 to decode the files and print them. The client 70 communicates with the printer 10 by accessing the IP address of the printer 10 via the network. The file receiving module 30, the file previewing module 40, the parameter setting module 50, and the print controlling module 60 may be constructed using HTML or ASP language. The file receiving module 30, the print previewing module 40, the print parameter setting module 50, and the print controlling module 60 cooperatively establish a print homepage 80 (shown in FIG. 2).

Referring to FIG. 2, the print homepage 80 has a title column 81, a tool column 82, an address column 83, and a main body 85. An uploading button 85 corresponding to the file receiving module 30, a previewing button 86 corresponding to the file previewing module 40, a setting button 88 corresponding to the parameter setting module previewing module 50, and a print button 89 corresponding to the print controlling module 60 are arranged on the main body 85. It is to be understood that the print 10 can also include other modules, and other buttons corresponding to the modules can also be arranged on the main body 85.

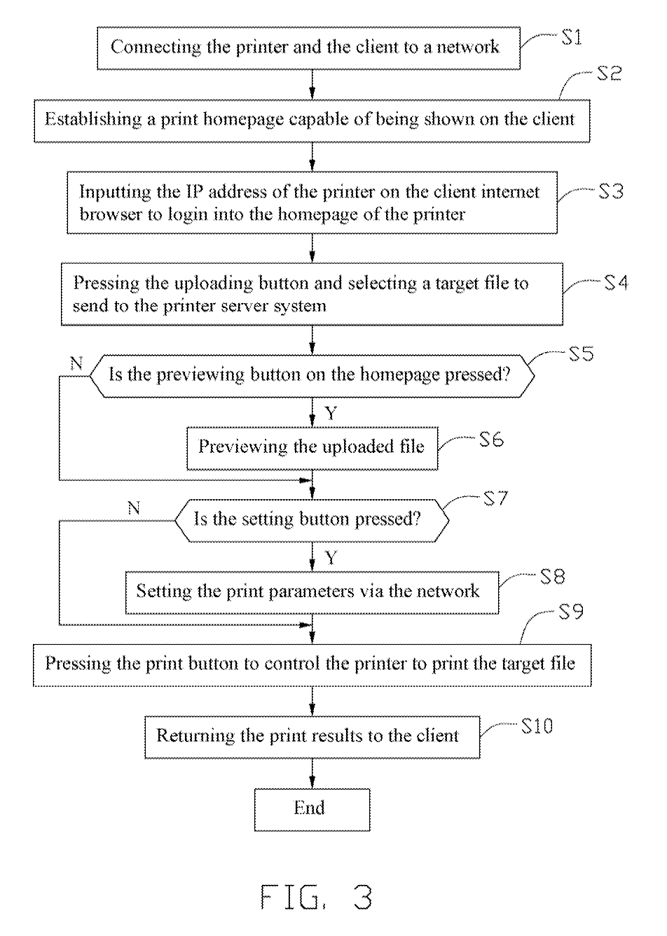

Referring to FIG. 3, the print method is described as follows:

Step 1: Connecting the printer 10 and the client 50 to a network. The printer 10 gets an IP address from the network.

Step 2: Establishing a print homepage 80 capable of being shown on the client 50.

Step 3: Opening the internet browser on the client 50, and inputting the IP address of the printer to navigate to and login into the homepage 80 of the printer 20.

Step 4: Pressing the uploading button 85 and selecting a target file to send to the printer server system 30.

Step 5: Determining whether the previewing button 86 on the homepage 80 is pressed. If the uploading button 85 is pressed, the print method goes to step 5; otherwise, the print method goes to step 6.

Step 6: Previewing the uploaded file.

Step 7: Determining whether the setting button 88 is pressed. If the setting button 88 is pressed, the print method goes to step 7; otherwise, the print method goes to step 8.

Step 8: Setting the print parameters via the network.

Step 9: Pressing the print button 89 to control the printer 10 to print the target file.

Step 10: Returning the print results to the client 70.

When printing a file by the above described print system and method, it is not necessary to install drivers corresponding to the printer 10 in the client 70. The client 70 can upload files for printing anytime and anywhere a network connection is available. Thus, printing on the fly becomes convenient.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A printing method, comprising:
connecting a printer and a client through a network;
presenting a print homepage shown on the client;
accessing the printer via the print homepage on the client;
sending an coded file to the printer from the client via the homepage;
receiving the coded file from the client by the printer; and
decoding the coded file and printing the file by the printer.

2. The printing method of claim 1, further comprising opening an internet browser of the client, and wherein the accessing the printer comprises of inputting the IP address of the printer on the internet browser to login into the print homepage.

3. The printing method of claim 1, wherein the file is sent to the printer upon the actuating of a file uploading button on the print homepage.

4. The printing method of claim 1, further comprising causing the printer to print the file upon the actuating of a print button on the print homepage.

5. The printing method of claim 1, further comprising previewing the file via the print homepage before the printer prints the file.

6. The printing method of claim 1, further comprising setting print parameters via the print homepage before the printer prints the file.

7. A printing system, comprising:
a client storing a coded file, the client comprising an internet browser;
a printer, the printer comprising a file receiving module capable of receiving the file from the client and a print controlling module capable of causing the printer to decode and print the coded file, the file receiving module and the print controlling module capable of cooperatively constructing a print homepage shown on the internet browser.

8. The printing system of claim 7, wherein the printer further comprises a file previewing module capable of previewing the file before the printer prints the file.

9. The printing system of claim 8, wherein the printer further comprises a parameter setting module capable of setting the print parameters for the printer.

10. The printing system of claim 9, wherein the file receiving module, the file previewing module, the parameter setting module, and the print controlling module capable of cooperatively constructing the home page.

11. The printing system of claim 10, wherein the homepage comprises an uploading button capable of actuating the file receiving module.

12. The printing system of claim 10,wherein the homepage comprises a previewing button capable of actuating the file previewing module.

13. The printing system of claim 10, wherein the homepage comprises a setting button capable of actuating the parameter setting module.

14. The printing system of claim 10, wherein the homepage comprises a printing button capable of actuating the print controlling module.
